(19) United States
(12) Patent Application Publication
(10) Pub. No.: US 2014/0147782 A1
(43) Pub. Date: May 29, 2014

(54) ELECTROSTATIC CHARGE IMAGE DEVELOPING TONER

(71) Applicant: KYOCERA DOCUMENT SOLUTIONS INC., Osaka (JP)

(72) Inventors: Toshiki TAKEMORI, Osaka (JP); Masanori SUGAHARA, Osaka (JP)

(73) Assignee: KYOCERA DOCUMENT SOLUTIONS INC., Osaka (JP)

(21) Appl. No.: 14/091,061

(22) Filed: Nov. 26, 2013

(30) Foreign Application Priority Data
Nov. 29, 2012 (JP) 2012-261594

(51) Int. Cl. G03G 9/093

(52) U.S. Cl. CPC G03G 9/09328
USPC 430/108.4

(57) ABSTRACT

For electrostatic charge image developing toner including toner base particles including a binder resin and a releasing agent, and an external additive attached to the toner base particles, an ester wax including a carboxylic acid component and an alcohol component each having a specific composition is used as the releasing agent, and an endothermic start temperature of the releasing agent is a predetermined temperature or more.

### INCORPORATION BY REFERENCE

The present application claims priority under 35 U.S.C. §119 to Japanese Patent Application No. 2012-261594, filed Nov. 29, 2012. The contents of this application are incorporated herein by reference in their entirety.

### BACKGROUND

The present application relates to electrostatic charge image developing toner.

Toner having excellent low temperature fixability is desired for achieving energy saving and compactness in device size. The toner having excellent low temperature fixability can be fixed by keeping heating of a fixing roller to a minimum. However, in many cases, the toner having excellent low temperature fixability includes a binder resin having a low melting point and a low glass transition point, and a releasing agent having a low melting point. Therefore, generally, the toner having excellent low temperature fixability has a problem of being likely to aggregate when stored at high temperature, or to cause difficulty in separating the fixing roller and the recording medium on which an image is formed because the toner melted adheres to the heated fixing roller.

To solve the problem as this, the toner as described below is suggested. The toner includes at least a binder resin, a wax that is a releasing agent, and a colorant. Resin particulates are attached to the surface of the toner. A glass transition point (Tg) of the resin included in the toner is 50° C. or more and 80° C. or less. It is possible to obtain an amount of wax exposure on a toner surface through extraction using hexane. The amount of the wax exposure on the toner surface is 18 mg/g or more and 30 mg/g or less. In this toner, a measurement value that is measured using Fourier transform infrared attenuated total reflectance (FTIR-ATR) is 0.1 or less.

### SUMMARY

The present disclosure provides the following. It should be noted that within the scope of the specification and the claims of the present disclosure, particles yet to be treated with an external additive are referred to as “toner base particles”.

An electrostatic charge image developing toner according to the present disclosure includes toner base particles and an external additive. The toner base particles include a binder resin and a releasing agent. The external additive is attached to a surface of the toner base particles. The releasing agent is an ester wax, the ester wax includes a carboxylic acid component and an alcohol component, and of the carboxylic acid component, a content in a fraction of a carbon number indicating a maximum peak in a carbon number distribution measured by gas chromatography is 90% by mass or more, and of the alcohol component, a content in a fraction of a carbon number indicating a maximum peak in a carbon number distribution measured by gas chromatography is 90% by mass or more. An endothermic start temperature of the releasing agent is 50° C. or more, the endothermic start temperature being measured using a differential scanning calorimeter (DSC).

### BRIEF DESCRIPTION OF THE DRAWINGS

FIG. 1 is a diagram showing thermal expansion coefficient curves of a releasing agent and a binder resin that are included in toner in Example 1.

FIG. 2 is a diagram showing a scanning electron microscope image of a toner surface before high-temperature environmental testing of the toner in Example 1.

FIG. 3 is a diagram showing a scanning electron microscope image of the toner surface after high-temperature environmental testing of the toner in Example 1.

FIG. 4 is a diagram showing a scanning electron microscope image of a toner surface before high-temperature environmental testing of the toner in Comparative Example 1.

FIG. 5 is a diagram showing a scanning electron microscope image of the toner surface after high-temperature environmental testing of the toner in Comparative Example 1.

### DETAILED DESCRIPTION

The following describes embodiments of the present disclosure in detail. The present disclosure is not limited to the embodiments below in any case, and is executable with modifications where appropriate within the scope of the purpose of the present disclosure. It should be noted that for the point where descriptions are overlapped, the description may be omitted where appropriate, which, however, is not to limit the content of the present disclosure.

The electrostatic charge image developing toner according to the present disclosure (hereinafter, also referred to as the toner) includes toner base particles and an external additive attached to the surface of the toner base particles. The toner base particles include a binder resin and a releasing agent. The releasing agent is an ester wax. The ester wax that is the releasing agent includes a carboxylic acid component and an alcohol component each of which includes a specific composition. The endothermic start temperature of the releasing agent is equal or over a predetermined temperature.

In addition, the toner according to the present disclosure may also be mixed with a desired carrier as a two component developer for use. The following describes in order, for the toner according to the present disclosure, the toner base particles, the external additive, a method for manufacturing the toner according to the present disclosure, and a carrier used in the case of using the toner according to the present disclosure as a two component developer.

### [Toner Base Particles]

The toner base particles included in the toner according to the present disclosure include a binder resin and a releasing agent. The toner base particles may include an optional component such as a colorant, a charge control agent, and magnetic powder, other than the binder resin and the releasing agent as essential components. The following describes the toner base particles including essential components (binder resin and releasing agent) and optional components (colorant, charge control agent, and magnetic powder).

### [Binder Resin]

The binder resin included in the toner base particles is not particularly limited as long as the binder resin for toner is used. For specific examples of the binder resin, it is possible to give a thermoplastic resin such as: styrene-based resin, acrylic resin, styrene-acrylic resin, polyethylene-based resin, polypropylene-based resin, vinyl chloride-based resin, polyester resin, polyamide resin, polyurethane resin, polyvinyl alcohol-based resin, vinyl ether-based resin, N-vinyl-based resin, or styrene-butadiene based resin. Among these resins, due to excellence in colorant dispersibility in the toner, toner chargeability, and toner fixability onto paper, the styrene-acrylic resin or the polyester resin is preferable. The following describes the styrene-acrylic resin and the polyester resin.

The styrene-acrylic resin is a copolymer of a styrene-based monomer and an acrylic monomer. For specific examples of the styrene-based monomer, it is possible to give a monomer such as: styrene, α-methylstyrene, vinyltoluene, α-chlorostyrene, o-chlorostyrene, m-chlorostyrene, p-chlorostyrene, or p-ethylstyrene. For specific examples of the acrylic monomer, it is possible to give (meth)acrylate alkyl ester such as: methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, or iso-butyl methacrylate.

For the polyester resin, it is possible to use resin obtained by condensation polymerization of an alcohol component that is divalent or of a valence of 3 or more, and a carboxylic acid component that is divalent or of a valence of 3 or more, or by copolycondensation of these. For a component used for synthesizing the polyester resin, an alcohol component that is divalent or of a valence of 3 or more, or a carboxylic acid component that is divalent or of a valence of 3 or more can be used as below.

For specific examples of the alcohol component that is divalent or of a valence of 3 or more, it is possible to give: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, or polytetramethylene glycol; bisphenols such as bisphenol A, hydrogenated bisphenol A, polyoxyethylene-modified bisphenol A, or polyoxypropylene-modified bisphenol A; or alcohols having a valence of 3 or more such as sorbitol, 1,2,3,6-hexanetetraol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, or 1,3,5-trihydroxymethylbenzene.

For specific examples of the carboxylic acid that is divalent or of a valence of 3 or more, it is possible to give: divalent carboxylic acid such as maleic acid, fumaric acid, citraconic acid, itaconic acid, glutaconic acid, phthalic acid, isophthalic acid, terephthalic acid, cyclohexanedicarboxylic acid, succinic acid, alkylsuccinic acid or alkenylsuccinic acid such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, or isododecenylsuccinic acid, adipic acid, sebacic acid, azelaic acid, and malonic acid; and carboxylic acid having a valence of 3 or more such as 1,2,4-benzene tricarboxylic acid (trimellitic acid), 1,2,5-benzene tricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, or EMPOL trimer acid. These carboxylic acid components that are divalent or of a valence of 3 or more may be formed as an ester-forming derivative such as acid halide, anhydride, or lower alkyl ester for use. Here, the “lower alkyl” refers to an alkyl group having the number of carbon atoms from 1 to 6.

In the case of using the polyester resin for the binder resin, a softening point of the polyester resin should preferably be 80° C. or more and 150° C. or less, and more preferably be 90° C. or more and 140° C. or less.

For the binder resin, for sufficient fixability, it is preferable to use a thermoplastic resin. However, not only can the thermoplastic resin be used as a binder resin by itself, but a crosslinking agent or a thermosetting resin can also be added to the thermoplastic resin. By partially introducing a crosslinking structure into the binder resin, it is possible to increase preservation stability, shape retention characteristic, and durability of the toner without reducing the toner fixability.

For the thermosetting resin that can be used with the thermoplastic resin, an epoxy resin or a cyanate-based resin is preferable. Specific example of a preferred thermosetting resin includes a thermosetting resin such as: bisphenol A type epoxy resin, hydrogenated bisphenol A type epoxy resin, novolac-type epoxy resin, poly(alkylene ether)-type epoxy resin, cyclic aliphatic-type epoxy resin, or cyanate resin. Two or more types of these thermosetting resins can be used in combination with each other.

The glass transition point (Tg) of the binder resin should preferably be 50° C. or more and 65° C. or less, and more preferably be 50° C. or more and 60° C. or less. If the glass transition point (Tg) of the binder resin is too low, there is a case where the toner melts and clings together in a development section of an image forming apparatus, or part of the toner melts and clings together during the transportation of the toner container or during storage in the warehouse. On the other hand, if the glass transition point (Tg) of the binder resin is too high, the strength of the binder resin decreases, and thus it becomes more likely to increase toner attachment to a latent image bearing member. In addition, if the glass transition point (Tg) of the binder resin is too high, there is a tendency that the toner is not sufficiently fixed at low temperature.

It should be noted that the glass transition point (Tg) of the binder resin can be obtained from a change point of specific heat of the binder resin, using a differential scanning calorimeter (DSC). More specifically, it is possible to obtain the glass transition point (Tg) of the binder resin by measuring an endothermic curve of the binder resin, using, for example, DSC-6200 manufactured by Seiko Instruments Inc as a measurement device. By placing 10 mg of the binder resin in an aluminum pan as a measurement sample and using an empty aluminum pan as a reference, measurement is performed under conditions that: a measurement temperature range is 25° C. or more and 200° C. or less and a temperature increase rate is 10° C./min under normal temperature and normal humidity, so as to obtain the endothermic curve. Using the endothermic curve of the binder resin that is obtained, it is possible to obtain the glass transition point (Tg) of the binder resin.

It is preferable that the number average molecular weight (Mn) of the binder resin be 2000 or more and 8000 or less. In addition, it is preferable that the mass average molecular weight (Mw) of the binder resin be 50000 or more and 150000 or less. By setting the number average molecular weight (Mn) and the mass average molecular weight (Mw) of the binder resin to such range, it is possible to obtain the toner that allows realizing sufficient fixability within a wider range of temperature. In addition, it is preferable that a molecular weight distribution (Mw/Mn), which is represented by a ratio between the number average molecular weight (Mn) and the mass average molecular weight (Mw), be 20 or more and 80 or less. By setting the molecular weight distribution of the binder resin to such range, it is possible to obtain the toner that allows realizing sufficient fixability within a wider range of temperature. The number average molecular weight (Mn) and the mass average molecular weight (Mw) of the binder resin can be measured using, for example, a gel permeation chromatography.

### [Releasing Agent]

The toner base particles included in the electrostatic charge image developing toner according to the present disclosure include the releasing agent for the purpose of improving fixability and offset resistance. The releasing agent used for the toner according to the present disclosure is an ester wax. The ester wax includes a carboxylic acid component and an alcohol component. A content of each component in a fraction of the carbon number that indicates a maximum peak in a carbon number distribution measured by gas chromatography is 90% by mass or more. In addition, for thermal characteristics of the releasing agent, the endothermic start temperature of the releasing agent measured by the differential scanning calorimeter (DSC) is 50° C. or more. The following describes the ester wax used as the releasing agent and the thermal characteristics of the releasing agent.

### (Ester Wax)

The ester wax used for the toner according to the present disclosure may be any one of a natural ester wax derived from a natural material and a synthetic ester wax that is chemically synthesized. As described earlier, according to the present disclosure, an ester wax which includes the carboxylic acid component and the alcohol component each having a predetermined composition is used. However, a generally available natural ester wax is a mixture of various ester compounds. Thus, the carboxylic acid component and the alcohol component included in the natural ester wax do not satisfy the predetermined requirement as above. Therefore, in the present disclosure, in the case of using the natural ester wax as the releasing agent, it is necessary to purify the natural ester wax using a publicly-known purification method.

For such conditions, the synthetic ester wax is preferable for the ester wax. This is because: in a stage before synthesis, by purifying, as necessary, the carboxylic acid component, the alcohol component, or both of them such that the content in the fraction of the carbon number that indicates the maximum peak in the carbon number distribution measured by gas chromatography is 90% by mass or more, it is possible to easily synthesize the ester wax used in the present disclosure. In addition, generally, the synthetic ester wax has a high content of the ester compound including the carboxylic acid component and the alcohol component each of which has a specific carbon number, thus making purification easy.

When the ester wax is the synthetic ester wax, the method of manufacturing the synthetic ester wax is not particularly limited as long as a chemical synthesis method is used. The synthetic ester wax may be synthesized using a known method such as a reaction between alcohol and carboxylic acid in the presence of an acid catalyst or a reaction between carboxylic acid halide and alcohol. It should be noted that the material for the synthetic ester wax may be derived from a natural material such as long-chain fatty acid manufactured from natural fat.

The ester wax includes the carboxylic acid component and the alcohol component. A content of each component in the fraction of the carbon number that indicates the maximum peak in the carbon number distribution measured by gas chromatography is 90% by mass or more. The following describes Wc and Wa. Wc represents a content of the carboxylic acid component in the fraction of the carbon number that indicates the maximum peak in the carbon number distribution measured by gas chromatography. In addition, Wa represents a content of the alcohol component in the fraction of the carbon number that indicates the maximum peak in the carbon number distribution measured by gas chromatography.

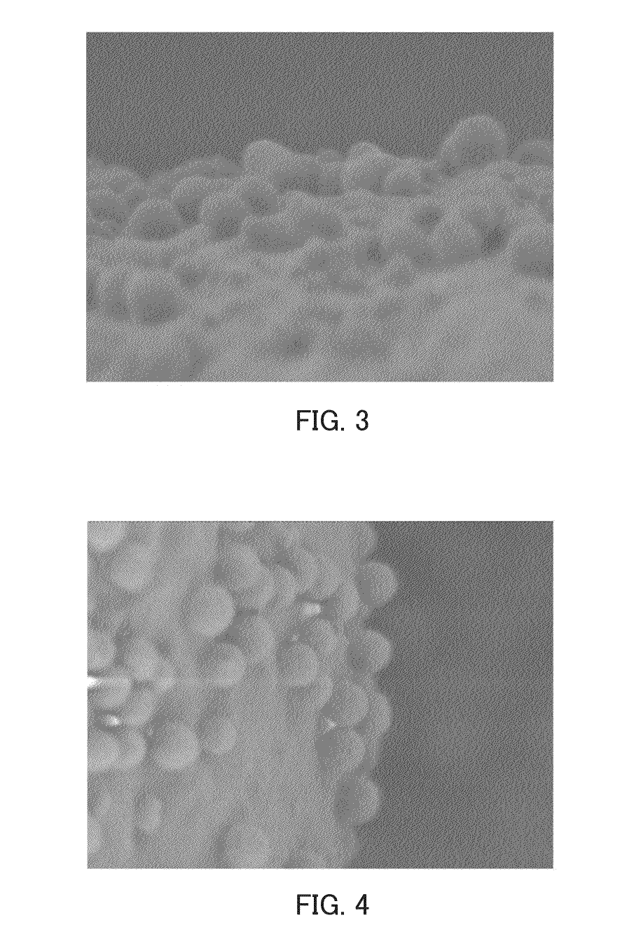

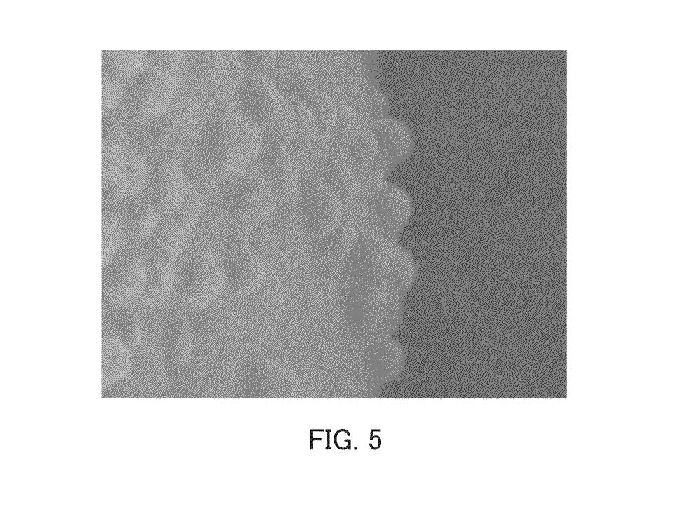

For the toner including the ester wax of which Wc and Wa are 90% by mass or more, FIGS. 2 and 3 show scanning electron microscope (SEM) images of the surface of the toner particles before and after storage at high temperature. On the other hand, for the toner including the ester wax of which Wc and Wa are below 90% by mass, FIGS. 4 and 5 show scanning electron microscope (SEM) images of the surface of the toner particles before and after storage at high temperature.

For the toner including the ester wax of which Wc and Wa at 90% by mass or more, a thermal expansion of the releasing agent is less likely to occur. Therefore, as shown in FIGS. 2 and 3, even in the case of storing the toner under high temperature environment, a surface state of the toner particles is less likely to change. Thus, if the thermal expansion of the releasing agent is less likely to occur under high-temperature environment, aggregation of the toner particles is less likely to occur even in the case of storing the toner under high temperature environment. Accordingly, it is easier to obtain the toner that is excellent in fixability and releasability between the fixing roller and the recording medium on which an image is formed. In addition, in the case of performing image formation under high temperature environment, the surface state of the toner particles is less likely to change, and therefore the fluidity of the toner is less likely to be deteriorated. With this, charging performance of the toner is maintained in a sufficient state. Even in the case of continuously performing image formation for a long period of time, it is possible to form an image having a desired image density.

By contrast, the toner including an ester wax of which We or Wa is too small, as shown in FIGS. 4 and 5, the thermal expansion of the releasing agent is likely to occur under high temperature environment. When the thermal expansion of the releasing agent occurs as shown in FIG. 5, much of the releasing component becomes exposed on the surface of the toner particles. Therefore, the aggregation of the toner particles is likely to occur. In addition, when the thermal expansion of the releasing agent occurs, as shown in FIG. 5, there is a case where the external additive on the surface of the toner base particles is covered with the releasing agent that is exposed on the surface of the toner base particles due to thermal expansion. Therefore, in the case of forming an image under high temperature environment, toner fluidity is deteriorated, and the toner is less likely to be sufficiently charged, thus making it difficult to form an image of a desired density.

The ester wax includes the carboxylic acid component and the alcohol component. The carbon number distribution of each component is measured using a gas chromatography. The carbon number distribution is measured, specifically, using the following method. For measuring the carbon number distribution, a gas chromatographer (“GC-14B” manufactured by Shimadzu Corp.) and a column (“Ultra ALLOY UA17-15M-0.25F” manufactured by Frontier Laboratories Ltd.) are used. A column temperature is increased from a start temperature of 150° C. to 320° C. at a temperature increase rate of 10° C./minute. By holding the column temperature at the same temperature for 33 minutes, and analyzing the carboxylic acid component, the alcohol component, or a mixture of both at an injection temperature of 350° C. and at a detection temperature of 350° C., it is possible to obtain the carbon number distribution of the carboxylic acid component or the alcohol component.

It should be noted that the ester wax includes the carboxylic acid component and the alcohol component. The carbon number distribution of each component can be obtained by measuring the carbon number distribution of the carboxylic acid component and the alcohol component before synthesis of the ester wax. In addition, after hydrolyzing the ester wax using an acid or a base so as to obtain the carboxylic acid component and the alcohol component, by measuring the carbon number distribution of the carboxylic acid component, the alcohol component, or the mixture of both, it is possible to obtain the carbon number distribution of the carboxylic acid component and the alcohol component. Furthermore, in the case of the ester wax being already mixed in the toner as the releasing agent, after separating the ester wax from the toner, it is possible to obtain the carbon number distribution of the carboxylic acid component and the alcohol component that are included in the separated ester wax, according to the method described above. It should be noted that the method for separating the ester wax that is the releasing agent from the toner is not particularly limited, but it is possible to give the method below.

### <The Method for Separating the Releasing Agent>

The toner is immersed in methyl ethyl ketone (MEK), and a sample obtained after allowing the toner to stand at 25° C. for 24 hours is filtered by glass filter (opening standard 11G-3). Next, the residue on the glass filter is immersed in toluene of 50° C., and is allowed to stand at 25° C. for 4 hours, thereby obtaining a sample. The sample thus obtained is filtered by glass filter (opening standard 11G-3). After allowing a filtrate thus obtained to stand for 12 hours, a supernatant liquid is taken. The supernatant liquid thus taken is vacuum dried at 60° C., and the releasing agent can be obtained as a residue remaining after drying.

### (Thermal Characteristics of the Releasing Agent)

The endothermic start temperature of the releasing agent, which is measured using the differential scanning calorimeter (DSC), should preferably be 50° C. or more, and more preferably be 50° C. or more and 60° C. or less. By using the releasing agent of which the endothermic start temperature measured using the differential scanning calorimeter (DSC) is 50° C. or more, it is easy to obtain such toner that is excellent in releasability between the fixing roller and the recording medium on which the image is formed, and in heat-resisting preservation stability. When the endothermic start temperature of the releasing agent is below 50° C., an offset is likely to occur at the time of image formation, and the releasability of the toner is likely to be deteriorated. In addition, when the endothermic start temperature of the releasing agent is below 50° C., in the case of storing the toner under high temperature environment, the releasing agent is likely to exude on the surface of the toner particles, and thus the heat-resisting preservation stability of the toner is likely to be deteriorated. It is possible to adjust the endothermic start temperature of the releasing agent, which is measured using the differential scanning calorimeter (DSC), by adjusting the carbon number of the ester compound that is a main component of the ester wax that is the releasing agent. The endothermic start temperature of the releasing agent tends to decrease when the carbon number of the ester compound that is the main component of the ester wax is decreased. On the other hand, the endothermic start temperature of the releasing agent tends to increase when the carbon number of the ester compound that is the main component of the ester wax is increased.

In addition, a maximum endothermic peak temperature of the releasing agent in a DSC curve that is measured using the differential scanning calorimeter (DSC) should preferably be 60° C. or more, and more preferably be 60° C. or more and 80° C. or less. When the maximum endothermic peak temperature of the releasing agent is below 60° C., there is a case where the fixability of the toner is deteriorated. For a method for adjusting the maximum endothermic peak temperature in the DSC curve, it is possible to perform the adjustment using the same method for the endothermic start temperature of the releasing agent. The following describes a method for DSC measurement.

### <Method for DSC Measurement>

The measurement is performed using the differential scanning calorimeter (“DSC-6200” manufactured by Seiko Instruments Inc.). The measurement is performed by setting the amount of a measurement sample to 10 mg, under the conditions: a measurement temperature range at 25° C. or more and 200° C. or less, and a temperature increase rate of 10° C./minute in a surrounding environment with normal temperature and normal humidity. The maximum endothermic peak temperature is calculated from the DSC curve of the measured sample. It should be noted that the temperature, at which a base line and the DSC curve become deviated from each other, is assumed as the endothermic start temperature.

In addition, it is preferable that a maximum value Vₘₐₓ of the thermal expansion coefficient of the releasing agent be 0.1% or less. It should be noted that the maximum value of the thermal expansion coefficient of the releasing agent is measured using a thermomechanical (TMA) analyzer. When the maximum value Vₘₐₓ of the thermal expansion coefficient of the releasing agent is 0.1% or less, even in the case of forming an image using the toner under high temperature environment, and in the case of storing the toner under high temperature environment, the releasing agent is less likely to exude from the toner base particles.

It is possible to adjust the maximum value Vₘₐₓ of the thermal expansion coefficient of the releasing agent by adjusting the carbon number distribution of the releasing agent. The maximum value Vₘₐₓ of the thermal expansion coefficient of the releasing agent tends to decrease by narrowing the carbon number distribution of the releasing agent, while the maximum value Vₘₐₓ of the thermal expansion coefficient of the releasing agent tends to increase by broadening the carbon number distribution of the releasing agent. In the measurement by thermomechanical analysis (TMA), it is possible to use a measurement device (“TMA/SS6100” manufactured by SII Nano Technology).

Various types of measurements to be performed on the releasing agent as described above may be performed on the releasing agent that is a material used for preparing the toner. In addition, such various types of measurements may be performed on the releasing agent separated from the toner.

The amount of use of the releasing agent should preferably be 1 part by mass or more and 10 parts by mass or less, with respect to 100 parts by mass of the binder resin. If the amount of use of the releasing agent is too small, there is a case where a desired effect cannot be produced in suppressing occurrence of offset or image smearing. On the other hand, if the amount of use of the releasing agent is too large, there is a case where the preservation stability of the toner decreases due to the toner particles melted and clinging together.

### [Colorant]

The toner base particles may include a colorant in the binder resin. The colorant included in the toner base particles is appropriately selected from among publicly known pigments or dyes according to the color of the toner particles. For specific examples of the preferred colorant to be added to the toner base particles, it is possible to give: a black pigment such as carbon black, acetylene black, lampblack, or aniline black; a yellow pigment such as chrome yellow, zinc yellow, cadmium yellow, yellow iron oxides, mineral fast yellow, nickel titanium yellow, Naples yellow, naphthol yellow S, hansa yellow G, hansa yellow 10G, benzidine yellow G, benzidine yellow GR, quinoline yellow lake, permanent yellow NCG, or tartrazine lake; an orange pigment such as orange chrome, molybdenum orange, permanent orange GTR, pyrazolone orange, vulcan orange, or indanthrene brilliant orange GK; a red pigment such as red iron oxide, cadmium red, red lead, cadmium mercury sulfide, permanent red 4R, lithol red, pyrazolone red, watching red calcium salt, lake red D, brilliant carmin 6B, eosin lake, rhodamine lake B, alizarin lake, or brilliant carmin 3B; a purple pigment such as manganese violet, fast violet B, or methyl violet lake; a blue pigment such as Prussian blue, cobalt blue, alkali blue lake, Victoria blue partial chlorinated product, fast sky blue, or indanthrene blue BC; a green pigment such as chrome green, chromium oxide, pigment green B, malachite green lake, or final yellow green G; a white pigment such as zinc oxide, titanium oxide, antimony white, or zinc sulfide; and an extender pigment such as baryta powder, barium carbonate, clay, silica, white carbon, talc, or alumina white. Two or more types of these colorants can be used in combination with each other for the purpose of adjusting a hue of the toner to a desired hue.

The amount of use of the colorant should preferably be 1 part by mass or more and 10 parts by mass or less, with respect to 100 parts by mass of the binder resin, and more preferably be 3 parts by mass or more and 8 parts by mass or less.

### [Charge Control Agent]

The toner base particles may include a charge control agent as necessary. The charge control agent improved a charge level stability and a charging startup characteristic of the toner, which indicates whether or not charging the toner up to a predetermined charge level is possible within the short time. Furthermore, the charge control agent is used for obtaining the toner having excellent durability and stability. In the case of positively charging the toner for performing development, a positively chargeable charge control agent is used. On the other hand, in the case of negatively charging the toner for performing development, a negatively chargeable charge control agent is used.

The type of the charge control agent is not particularly limited and can be appropriately selected from among charge control agents used for toner. For specific examples of the positively chargeable charge control agent, it is possible to give: an azine compound such as pyridazine, pyrimidine, pyrazine, ortho-oxazine, meta-oxazine, para-oxazine, ortho-thiazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, or quinoxaline; direct dyes including an azine compound such as azine fast red FC, azine fast red 12BK, azine violet BO, azine brown 3G, azine light brown GR, azine dark green BH/C, azine deep black EW, or azine deep black 3RL; a nigrosine compound such as nigrosine, nigrosine salt, or a nigrosine derivative; an acid dye made from a nigrosine compound such as nigrosine BK, nigrosine NB, or nigrosine Z; metal salts of naphthenic acid or higher fatty acid; alkoxylated amine; alkylamide; and quarternary ammonium salt such as benzylmethylhexyldecylammonium or decyltrimethylammonium chloride. Among these positively chargeable charge control agents, the nigrosine compound is particularly preferred for a reason of achieving quicker charging startup characteristic. Two or more types of these positively chargeable charge control agents can be used in combination with each other.

Resin with a quaternary ammonium salt, a carboxylate salt, or a carboxyl group as a functional group may also be used as the positively chargeable charge control agent. More specifically, it is possible to give: styrene-based resin with a quaternary ammonium salt, acrylic resin with a quaternary ammonium salt, styrene-acrylic resin with a quaternary ammonium salt, polyester resin with a quaternary ammonium salt, styrene-based resin with a carboxylate salt, acrylic resin with a carboxylate salt, styrene-acrylic resin with a carboxylate salt, polyester resin with a carboxylate salt, styrene-based resin with a carboxyl group, acrylic resin with a carboxyl group, styrene-acrylic resin with a carboxyl group, or polyester resin with a carboxyl group. The molecular weight of such resins is not particularly limited and may be an oligomer or a polymer.

For a specific example of the negatively chargeable charge control agent, it is possible to give an organometallic complex or a chelate compound. For the organometallic complex or the chelate compound, it is preferable to use: a metal acetylacetonate complex such as aluminum acetylacetonate or iron(II) acetylacetonate, or a salicylic acid-based metal complex such as 3,5-di-tert-butylsalicylic acid chromium, or salicylic acid-based metal salt. The salicylic acid-based metal complex or the salicylic acid-based metal salt is more preferable. Two or more types of these negatively chargeable charge control agents can be used in combination with each other.

The amount of use of the positively or negatively chargeable charge control agent should preferably be 1.5 parts by mass or more and 15 parts by mass or less, with respect to 100 parts by mass of the total amount of toner, and more preferably be 2.0 parts by mass or more and 8.0 parts by mass or less. If the amount of use of the charge control agent is too small, it is difficult to stably charge the toner to a predetermined polarity. Thus, there is a case where the image density of the formed image is below a predetermined level or it becomes difficult to maintain the image density for a long time. In addition, in this case, it is difficult to uniformly disperse the charge control agent within the toner, thus making it more likely to cause fogging in the formed image or stain on the latent image bearing member by the toner. On the other hand, if the amount of use of the charge control agent is too large, it is likely to cause an insufficient charging state of the toner under high temperature and high humidity due to deterioration in environment resistance of the toner. In this case, problems such as image defect in the formed image or stain on the latent image bearing member are more likely to occur.

### [Magnetic Powder]

The toner base particles may include magnetic powder as desired. The type of the magnetic powder is not particularly limited. For a preferred example of the magnetic powder, it is possible to give: iron such as ferrite or magnetite; ferromagnetic metal such as cobalt or nickel; an alloy including iron and/or ferromagnetic metal; a compound including iron and/or ferromagnetic metal; a ferromagnetic alloy treated by ferromagnetic treatment such as heat treatment; and chromium dioxide.

A particle diameter of the magnetic powder should preferably be 0.1 μm or more and 1.0 μm or less, and more preferably be 0.1 μm or more and 0.5 μm or less. In the case of using the magnetic powder having a particle diameter within the range as described above, it is easier to uniformly disperse the magnetic powder within the binder resin.

For the magnetic powder, to improve the dispersibility of the magnetic powder in the binder resin, it is possible to use a magnetic powder that is surface-treated with a surface preparation agent such as a titanium coupling agent or a silane coupling agent.

The amount of use of the magnetic powder, in the case of using the toner as a one component developer, should preferably be 35 parts by mass or more and 60 parts by mass or less, with respect to 100 parts by mass of the total amount of toner, and more preferably be 40 parts by mass or more and 60 parts by mass or less. If the amount of use of the magnetic powder is too large, there is a case where it is difficult to maintain the image density at a desired level for a long time or the toner fixability of the toner onto the paper is extremely reduced. On the other hand, if the amount of use of the magnetic powder is too small, there is a case where the formed image is likely to have fogging or it becomes difficult to maintain the image density at a desired level for a long time. In addition, in the case of using the toner as a two component developer, the amount of the magnetic powder should preferably be 20% by mass or less with respect to 100 parts by mass of the total toner amount of the toner, and more preferably be 15% by mass or less.

### [External Additive]

In the electrostatic charge image developing toner according to the present disclosure, an external additive is attached to the surface of the toner base particles. The types of the external additive can be appropriately selected from external additives for toner. For specific examples of the preferred external additive, it is possible to give: silica, or metal oxide such as alumina, titanium oxide, magnesium oxide, zinc oxide, strontium titanate, and barium titanate. Two or more types of these external additives can be used in combination with each other. Of these external additives, it is preferable to use silica as the external additive because it becomes easier to obtain the toner having excellent fluidity.

These external additives can also be hydrophobized for use, using a hydrophobizing agent such as an aminosilane coupling agent or silicone oil. In the case of using a hydrophobized external additive, it becomes easier to suppress decrease in charge amount of the toner under high temperature and high humidity, and also it becomes easier to obtain the toner having excellent fluidity.

A particle diameter of the external additive should preferably be 0.01 μm or more and 1.0 μm or less.

The amount of use of the external additive should preferably be below 2.5 parts by mass with respect to 100 parts by mass of toner particles before treatment with the external additive (toner base particles), more preferably be 0.1 parts by mass or more and below 2.5 parts by mass, and further preferably be 0.1 parts by mass or more and 2 parts by mass or less.

### [Method for Manufacturing the Electrostatic Charge Image Developing Toner]

For a method for manufacturing the electrostatic charge image developing toner according to the present disclosure, the electrostatic charge image developing toner can be obtained by attaching the external additive to the surface of the toner base particles. Then, the method for manufacturing the toner base particle is not particularly limited as long as the method allows mixing of the releasing agent with the binder resin and thereby allows manufacturing of the toner base particles including the components as described above as necessary. For preferred methods, it is possible to give a pulverizing method and an aggregation method. In the pulverizing method, essential components (the binder resin and the releasing agent), and an optional component (the colorant, the charge control agent, and the magnetic powder) are mixed, and a mixture obtained thereby is melted and kneaded by a melt-kneader such as a single-axis or biaxial extruder, and a product thus obtained from the melting and kneading is pulverized and classified, thereby obtaining toner base particles. In the aggregation method, particulates of the components included in the toner, such as the binder resin, the releasing agent, and the colorant, are aggregated in an aqueous medium, thereby obtaining aggregated particles. Next, the aggregated particles are heated so as to coalesce components included in the aggregated particles, thereby obtaining the toner base particles. Of these methods, the pulverizing method is the more preferable. Generally, an average particle diameter of the toner base particles should preferably be 5 μm or more and 10 μm or less.

Next, the surface of the toner base particles thus obtained may be treated with an external additive. The method for treating the toner base particles using an external additive can be selected appropriately from among conventionally known treatment methods using external additives. Specifically, conditions for external addition treatment are adjusted such that the particles of the external additives are not embedded in the toner base particles, and the treatment using the external additive is performed, using a mixer such as a Henschel mixer or a Nauta Mixer.

### (Specific Surface Area)

For the toner thus obtained, a BET specific surface area of unused toner after being allowed to stand for 24 hours in an environment at 23° C. and 50% RH is assumed as S₁. Then, when assuming, as S₂, a BET specific surface area of the unused toner after being allowed to stand for 24 hours in an environment at 45° C. and 16% RH, a specific surface area decreasing rate is calculated using the following formula.

Specific surface area decreasing rate [%]=(1−S₂/S₁)×100

The specific surface area decreasing rate should preferably be 11% or more and 14% or less. By setting the specific surface area decreasing rate of the toner to such range, it is possible to obtain the toner in which the surface state of the toner particles is less likely to change when storing the toner under high temperature environment (45° C., 16% RH). As a method for adjusting the specific surface area decreasing rate of the toner, which is measured with such conditions, as described above, it is possible to give a method for adjusting the maximum value Vₘₐₓ of the thermal expansion coefficient of the releasing agent or a method for adjusting the amount of the external additive. It should be noted that the BET specific surface area of the toner can be measured using a specific surface area measurement device (“Macsorb 1208” manufactured by Mountech Co., Ltd.).

### [Carrier]

The electrostatic charge image developing toner according to the present disclosure can also be mixed with a desired carrier for use as a two component developer. For preparing the two component developer, it is preferable to use a magnetic carrier.

For an example of a preferred carrier, it is possible to give a carrier having a carrier core coated with resin. For specific examples of the carrier core, it is possible to give: particles of metal such as iron, oxidatively-treated iron, reduced iron, magnetite, copper, silicon steel, ferrite, nickel, or cobalt; particles of an alloy made from these materials and metal such as manganese, zinc, or aluminum; particles of an iron alloy such as a nickel-iron alloy or a cobalt-iron alloy; particles of ceramics such as titanium oxide, aluminum oxide, copper oxide, magnesium oxide, lead oxide, zirconium oxide, silicon carbide, magnesium titanate, barium titanate, lithium titanate, lead titanate, lead zirconate, or lithium niobate; particles of a high-permittivity substance such as ammonium dihydrogen phosphate, potassium dihydrogen phosphate, or Rochelle salt; and a resin carrier core formed by dispersing the above magnetic powder in resin.

For specific examples of the resin for coating the carrier core, it is possible to give: a (meth)acrylic polymer, a styrene-based polymer, a styrene-(meth)acrylic copolymer, an olefin-based polymer (polyethylene, chlorinated polyethylene, or polypropylene), polyvinyl chloride, polyvinyl acetate, polycarbonate, cellulose resin, polyester resin, unsaturated polyester resin, polyamide resin, polyurethane resin, epoxy resin, silicone resin, fluororesin (polytetrafluoroethylene, polychlorotrifluoroethylene, or polyvinylidene fluoride), phenol resin, xylene resin, diallyl phthalate resin, polyacetal resin, or amino resin. Two or more types of these resins can be used in combination with each other.

A particle diameter of the carrier is measured using an electron microscope. The particle diameter of the carrier should preferably be 20 μm or more and 120 μm or less, and more preferably be 25 μm or more and 80 μm or less.

In the case of using the toner according to the present disclosure as a two component developer, a toner content in the two component developer should preferably be 3% by mass or more and 20% by mass or less with respect to the mass of the two component developer, and more preferably be 5% by mass or more and 15% by mass or less. By setting the toner content in the two component developer to such range, it becomes easier to maintain the image density of the formed image at an appropriate level as well as suppress toner scattering from the developing device, thus suppressing toner stain on an inner part of the image forming apparatus or toner attachment to transfer paper.

As described above, the electrostatic charge image developing toner according to the present disclosure is excellent in releasability between the fixing roller and the recording medium on which the image is formed, heat-resisting preservation stability, and fixability. Furthermore, the electrostatic charge image developing toner according to the present disclosure allows forming of an image having a desired image density in the case of continuously performing image formation under high temperature environment. Thus, the electrostatic charge image developing toner according to the present disclosure is preferably used in various image forming apparatuses.

### EXAMPLES

The following describes the present disclosure in further detail using examples. It should be noted that the present disclosure is not to be limited in any case by the scope of the examples according to the present disclosure.

In each of the examples and comparative examples, releasing agents A to J were used. Methods for manufacturing the releasing agents A to J are described in Preparation Example 1. In addition, the ester wax used as the releasing agent is made from the carboxylic acid component and the alcohol component. We represents a content of the carboxylic acid component in a fraction of the carbon number that indicates the maximum peak in the carbon number distribution measured by gas chromatography. Wa represents a content of the alcohol acid component in the carbon number that indicates the maximum peak in the carbon number distribution measured by gas chromatography.

### Preparation Example 1

### Preparing Releasing Agents A to J

The releasing agents A to J, which were ester waxes, were prepared using the carboxylic acid component and the alcohol component each having the carbon number distribution as described in Table 1, according to the procedure below. It should be noted that the carbon number distribution is measured by gas chromatography. A four neck flask of a 1 liter capacity having a thermometer, a nitrogen introduction tube, a stirrer, and a cooling tube was used as a reaction container. To the reaction container, 50 parts by mass of the carboxylic acid component and 50 parts by mass of the alcohol component, each of which is of the type described in Table 2, were added. Next, under nitrogen gas stream, by causing a reaction at 220° C. and at normal pressure for 15 hours while distilling away by-product water, an esterification crude product was obtained. 20 parts by mass of ion-exchange water was added to 100 parts by mass of the esterification crude product obtained, which was stirred for 30 minutes at 70° C. Subsequently, after being allowed to stand for 30 minutes, an aqueous layer was separated and removed. Water washing was repeatedly performed until pH of the separated aqueous layer became neutral. The remaining ester layer was heated to 180° C. under a condition of reduced pressure of 1 kPa so as to remove volatile, thereby obtaining the ester wax.

### <Method for Measuring the Carbon Number Distribution>

Using a gas chromatographer (“GC-14B” manufactured by Shimadzu Corp.) and a column (“Ultra ALLOY UA17-15M-0.25F” manufactured by Frontier Laboratories Ltd.), the carbon number distribution was measured. A column temperature was increased from a start temperature of 150° C. to 320° C. at a temperature increase rate of 10° C./minute, the column temperature was held at the same temperature for 33 minutes, and a sample was analyzed at an injection temperature of 350° C. and a detection temperature of 350° C.

TABLE 1

| | | Carbon number | | | | | | | |
|---|---|---|---|---|---|---|---|---|---|
| | | 12 | 14 | 16 | 18 | 20 | 22 | 24 | 26 |
| Car- | Behenic acid A | — | — | — | 1 | 4 | 93 | 2 | — |
| boxylic | [% by mass] | | | | | | | | |
| acid | Behenic acid B | — | — | — | 4 | 14 | 82 | — | — |
| com- | [% by mass] | | | | | | | | |
| ponent | Palmitic acid A | — | 1 | 95 | 4 | — | — | — | — |
| | [% by mass] | | | | | | | | |
| | Palmitic acid B | — | 12 | 88 | — | — | — | — | — |
| | [% by mass] | | | | | | | | |
| Alcohol | Behenyl alcohol A | — | — | — | 2 | 6 | 90 | 2 | — |
| com- | [% by mass] | | | | | | | | |
| ponent | Behenyl alcohol B | — | — | — | 8 | 16 | 74 | 2 | — |
| | [% by mass] | | | | | | | | |
| | Stearyl alcohol A | — | — | 2 | 98 | — | — | — | — |
| | [% by mass] | | | | | | | | |
| | Stearyl alcohol B | — | — | 16 | 82 | 2 | — | — | — |
| | [% by mass] | | | | | | | | |

TABLE 2

| | Carboxylic acid | Alcohol |
|---|---|---|
| Releasing | component | component |
| agent | Type | Type |
| A | Behenic acid A | Behenyl |
| | | alcohol A |
| B | Behenic acid A | Stearyl |
| | | alcohol A |
| C | Palmitic acid A | Behenyl |
| | | alcohol A |
| D | Behenic acid B | Behenyl |
| | | alcohol B |
| E | Behenic acid A | Behenyl |
| | | alcohol B |
| F | Behenic acid B | Behenyl |
| | | alcohol A |
| G | Palmitic acid A | Behenyl |
| | | alcohol B |
| H | Palmitic acid A | Stearyl |
| | | alcohol A |
| I | Palmitic acid A | Stearyl |
| | | alcohol B |
| J | Palmitic acid B | Behenyl |
| | | alcohol A |

### Examples 1 to 4, and Comparative Examples 1 to 9

To 100 parts by mass of the polyester resin (“TAFUTON” manufactured by Kao Corporation) as the binder resin, 5 parts by mass of the releasing agent of the type as described in Tables 3 to 5, 4 parts by mass of the colorant (“Carbon Black (MA-100)” manufactured by Mitsubishi Chemical Corporation), and 2 pats by mass of the charge control agent (“N-01” manufactured by ORIENT CHEMICAL INDUSTRIES, Co., Ltd.) were mixed using a Henschel mixer (“FM-20B” manufactured by Nippon Coke & Engineering Co., Ltd). The mixture thus obtained was melted and kneaded using a biaxial extruder (“PCM-30” manufactured by Ikegai Corp.), under the condition of a material feed speed of 5 kg/hr, a shaft rotation rate of 150 rpm, and a cylinder temperature of 150° C., thereby obtaining a product resulting from the melting and kneading. The product resulting from the melting and kneading was coarsely pulverized using a grinder (“Rotoplex mill 8/16” manufactured by TOA MACHINERY MFG Co., LTD.). Next, the coarsely pulverized product was finely pulverized using a jet mill (“Ultrasonic Jet Mill Type I” Nippon Pneumatic Mfg. Co., Ltd.). The finely pulverized product was classified using Elbow-jet (“EJ-LABO” manufactured by Nittetsu Mining Co., Ltd.), thereby obtaining toner base particles having a mean volume particle diameter of approximately 6.0 μm. The measurement of the mean volume particle diameter of the toner base particles was performed using a Multisizer 3 (manufactured by Beckman Coulter, Inc.).

To 100 parts by mass of the toner base particles thus obtained, hydrophobic silica particulates of the amount described in Tables 3 to 5 (“RA-200H” manufactured by Nippon Aerosil Co., Ltd.) and 0.5 parts by mass of titanium oxide particulates (“ST-100” manufactured by Titan Kogyo, Ltd.) were added, which was mixed using a Henschel mixer (“FM-20B” manufactured by Nippon Coke & Engineering Co., Ltd) at a rotation rate of 2000 rpm and a jacket control temperature of 25° C. for 2 minutes, and external addition treatment was performed. As a result, the toner in each of Examples 1 to 4 and Comparative Examples 1 to 9 was obtained.

[symbol]

Thermal Characteristics Analysis

[symbol]

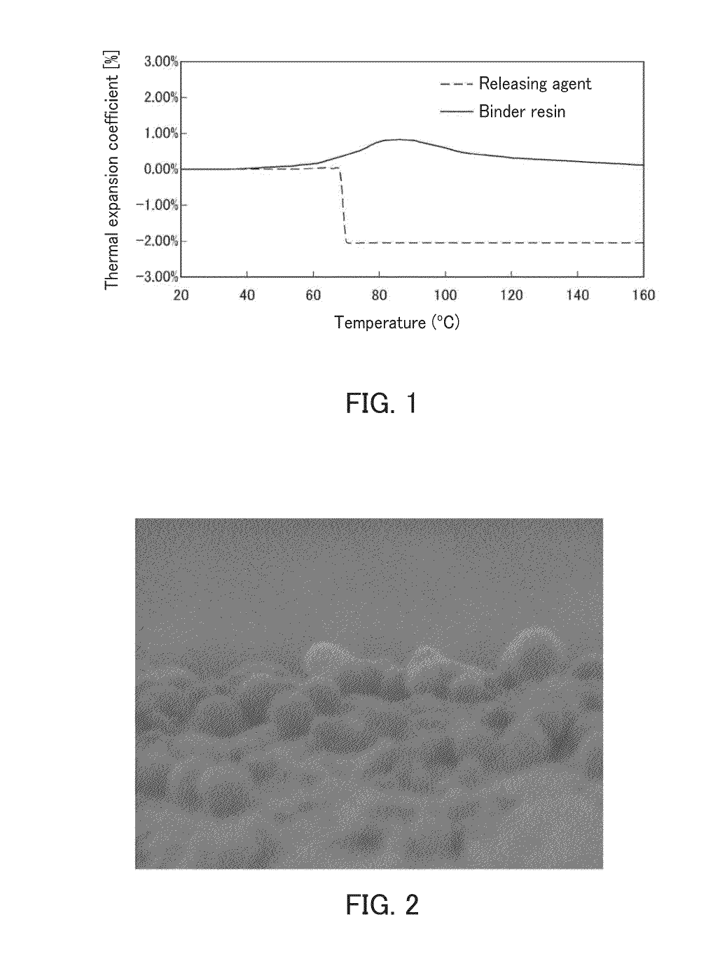

The releasing agent was separated from the toner in each of Examples 1 to 4 and Comparative Examples 1 to 9, according to the method below. Next, for the releasing agent obtained by the separation, the endothermic start temperature of the releasing agent and a DSC curve of the releasing agent were measured according to a DSC measurement method as described below. In addition, the thermal expansion coefficient curve of the releasing agent was measured according to a TMA measurement method. From the DSC curve of the releasing agent thus obtained, a maximum endothermic peak temperature of the releasing agent was obtained, and from the thermal expansion coefficient curve of the releasing agent thus obtained, the maximum thermal expansion coefficient (Vₘₐₓ) of the releasing agent was obtained. Tables 3 to 5 describe results of the measurement of the endothermic start temperature, a maximum endothermic peak temperature, and the maximum thermal expansion coefficient (Vₘₐₓ) of the releasing agent used for the toner in each of Examples 1 to 4 and Comparative Examples 1 to 9. In addition, FIG. 1 shows the thermal expansion coefficient curve of the releasing agent included in the toner in Example 1.

### <Method for Separating the Releasing Agent>

0.1 g of toner was immersed in 30 ml of methyl ethyl ketone (MEK), which was allowed to stand at 25° C. for 24 hours, thereby obtaining a sample. Then, the sample thus obtained was filtered by glass filter (opening standard 11G-3). A filtrate was allowed to stand for 12 hours, and a supernatant liquid was taken. The supernatant liquid thus taken was vacuum dried at 60° C., thereby obtaining the binder resin as a residue remaining after drying. Next, the residue on the glass filter was immersed in 30 ml of toluene of 50° C., which was allowed to stand at 25° C. for 4 hours, thereby obtaining a sample. Then, the sample thus obtained was filtered by glass filter (opening standard 11G-3). After allowing a filtrate to stand for 12 hours, a supernatant liquid was taken. The supernatant liquid was vacuum dried at 60° C., thereby obtaining the releasing agent as a residue after drying.

### <DSC Measurement Method>

The measurement is performed using a differential scanning calorimeter (“DSC-200” manufactured by Seiko Instruments Inc.). By setting the amount of a measurement sample to 10 mg and a measurement temperature range to a range from normal temperature to 200° C., at a temperature increase rate to 30° C./minute, the endothermic start temperature of the measurement sample and the DSC curve of the measurement sample were measured. Then, from the DSC curve that is measured, a temperature at which a bottom of the maximum endothermic peak was obtained as the maximum endothermic peak temperature.

### <TMA Measurement Method>

The measurement was performed using a thermomechanical (TMA) analyzer (TMA/SS6100 manufactured by Seiko Instruments Inc). At a sample thickness of 2.5 mm, a prove weight of 50 mN, and a temperature increase rate of 2.0° C./minute, the thermal expansion coefficient of the sample was measured by varying the temperature from 20° C. to 160° C.

FIG. 1 shows the thermal expansion coefficient curve of each of the releasing agent and the binder resin that are included in the toner in Example 1. From the thermal expansion coefficient curve shown in FIG. 1, the maximum thermal expansion coefficient (Vₘₐₓ) was obtained as described in Table 3.

[symbol]

SEM Observation

[symbol]

Using a scanning electron microscope (“JSM-7500F” manufactured by JEOL Ltd.), the surface of the toner particles in each of Example 1 and Comparative Example 1 before and after being allowed to stand for 24 hours in an environment at 45° C. and 16% RH (high-temperature environmental testing) was observed at 100000-fold magnification. For the toner in Example 1, a SEM image of the toner surface before the high-temperature environmental testing is shown in FIG. 2, and a SEM image of the toner surface after the high-temperature environmental testing is shown in FIG. 3. In addition, for the toner in Comparative Example 1, a SEM image of the toner surface before the high-temperature environmental testing is shown in FIG. 4, and a SEM image of the toner surface after the high-temperature environmental testing is shown in FIG. 5.

As shown in FIGS. 2 and 3, it is shown that a surface state of the toner particles in the toner in Example 1 did not change before and after the high-temperature environmental testing. The toner in Example 1 includes an ester wax in which Wc and Wa are 90% by mass or more. On the other hand, as shown in FIGS. 4 and 5, it is shown that for the toner in Comparative Example 1, the surface of the toner particles is covered with a releasing agent component that is expanded. The toner in Comparative Example 1 includes an ester wax in which both Wc and Wa are too small.

[symbol]

Specific Surface Area Measurement

[symbol]

After allowing 1 g of unused toner in each of Examples 1 to 4 and Comparative Examples 1 to 9 to stand for 24 hours in an environment at 23° C. and 50% RH, a BET specific surface area (S₁) was measured using a BET specific surface area measurement device (“Macsorb 1208” manufactured by Mountech Co., Ltd.). In addition, according to the same measurement method as S₁ except that temperature and humidity conditions were changed to 45° C. and 16% RH, a BET specific surface area (S₂) was measured. From the values of S₁ and S₂ obtained, a specific surface area decreasing rate was calculated using a formula below.

Specific surface area decreasing rate [%]=((S₁−S₂)/S₁)×100

### Evaluation 1

For the toner in each of Examples 1 to 4 and Comparative Examples 1 to 9, heat-resisting preservation stability was evaluated. Tables 3 to 5 describe results of the evaluation for the heat-resisting preservation stability of the toner in each of Examples 1 to 4 and Comparative Examples 1 to 9.

### <Heat-Resisting Preservation Stability>

5 g of toner was weighed in a sample bottle made of glass, and after being allowed to stand for 24 hours in a constant temperature reservoir (“DKN302” manufactured by Yamato Scientific Co., Ltd.) of 55° C., the sample bottle containing the toner was cooled to the room temperature. The cooled toner is sieved with a 400-mesh sieve, using a powder tester (manufactured by Hosokawa Micron Corporation) under a condition of a vibration scale of 5. The mass of the toner (T)[g] which passed the sieve was measured, and a toner passage rate was calculated using a formula below.

Toner passage rate [%]=T/5×100

The heat-resisting preservation stability was evaluated according to a reference below.

Good: The toner passage rate was 80% or more.
Poor: The toner passage rate was below 80%.

### Evaluation 2

Using the toner in each of Examples 1 to 4 and Comparative Examples 1 to 9, image density, fixability, and releasability were evaluated according to the method below. As an evaluation device, a color printer (“FS-05300DN” manufactured by Kyocera Document Solutions Inc.) was used. It should be noted that the evaluation was performed using the two component developer prepared according to the method below. Tables 3 to 5 describe results of the evaluation for the toner in each of Examples 1 to 4 and Comparative Examples 1 to 9.

### Preparation Example 2

### Preparation of the Two Component Developer

10 parts by mass of toner was mixed with 100 parts by mass of the carrier used for the color printer (“FS-05300DN” manufactured by Kyocera Document Solutions Inc.), and the mixture was encapsulated in a plastic bottle and rotated for 30 minutes at a rotation speed of 100 rpm by a ball mill (manufactured by Kyocera Document Solutions Inc.) so as to uniformly stir and mix the carrier and the toner in the plastic bottle, thereby obtaining the two component developer.

### <Image Density>

Using the evaluation device, evaluation of image density was performed under each of an environment at 23° C., 50% RH and an environment at 45° C. and 16% RH. After continuously printing 10000 pages at a coverage rate of 4%, a solid image having a coverage rate of 100% was formed on a recording medium. The image density of the solid image thus formed was measured using a reflection densitometer (“GretagMacbeth SpectroEye” manufactured by Gretag Macbeth). The image density was evaluated according to a reference below.

Very good: The image density was 1.20 or more.
Good: The image density was 1.00 or more and below 1.20.
Poor: The image density was below 1.00.

### <Fixability>

Using the evaluation device, a solid image having a coverage rate of 100% was formed on the recording medium. A point on the solid image, which has an image density of 1.20 or more and 1.25 or less, was frictioned back and forth five times using a weight of 500 g covered with cloth such that only the self-weight of the weight was loaded on the image, and the image density after the friction was measured. The image density was measured using the reflection densitometer (“GretagMacbeth SpectroEye” manufactured by Gretag Macbeth). According to a formula below, the fixing rate was calculated from the image density before and after the friction.

Fixing rate (%)=(image density after friction/image density before friction)×100

The fixability was evaluated according to a reference below.

Very good: The fixing rate was 90% or more.
Good: The fixing rate was 80% or more and below 90%.
Poor: The fixing rate was below 80%.

### <Releasability>

Using the evaluation device, and by changing a toner mount amount from 1.00 mg/cm² to 1.80 mg/cm² in increments of 0.1 mg/cm², a solid image having a coverage rate of 100% was formed on a recording medium, and the toner mount amount (mg/cm²) that did not cause the recording medium to wind around the fixing roller was assumed as a separable toner mount amount. The releasability was evaluated according to a reference below. The reference for determining the evaluation of the releasability is as follows.

Very good: The toner mount amount was over 1.5 mg/cm².
Good: The toner mount amount was over 1.2 mg/cm², and 1.5 mg/cm² or less.
Poor: The toner mount amount was 1.2 mg/cm² or less.

TABLE 3

| | | Example | | | |
|---|---|---|---|---|---|
| | | 1 | 2 | 3 | 4 |
| Releasing agent | | | | | |
| Type | | A | B | C | A |
| Maximum | Carboxylic acid | 93 | 93 | 95 | 93 |
| peak | component | | | | |
| carbon number | (Wc) [% by mass] | | | | |
| content | Alcohol | 90 | 98 | 90 | 90 |
| | component | | | | |
| | (Wa) [% by mass] | | | | |

| | | | | |
|---|---|---|---|---|
| Hydrophobic silica | 1 | 1 | 1 | 2 |
| Content [part by mass] | | | | |
| Thermal characteristic analysis | | | | |
| Endothermic start temperature [° C.] | 58.3 | 52.9 | 50.1 | 58.3 |
| Endothermic peak temperature [° C.] | 73.2 | 65.5 | 60.2 | 73.2 |
| Maximum thermal expansion | 0.05 | 0.09 | 0.10 | 0.05 |
| coefficient (Vₘₐₓ) [%] | | | | |
| Specific surface measurement | | | | |
| S₁ [m²/g] | 1.83 | 1.79 | 1.81 | 2.23 |
| S₂ [m²/g] | 1.62 | 1.54 | 1.55 | 1.99 |
| Specific surface area decreasing rate | 11.4 | 14.0 | 14.3 | 10.9 |
| [%] | | | | |
| Evaluation 1 | | | | |
| Heat-resisting preservation stability | | | | |
| Mesh passage rate [%] | 92 | 83.3 | 80.2 | 92.9 |
| Evaluation | Good | Good | Good | Good |
| Evaluation 2 | | | | |
| Image density | | | | |
| Under 23° C. 50% RH environment | 1.25 | 1.23 | 1.21 | 1.28 |
| Under 45° C. 16% RH environment | 1.13 | 1.08 | 1.02 | 1.21 |
| Evaluation | Good | Good | Good | Very |
| | | | | good |
| Fixability | | | | |
| Density after friction | 1.01 | 1.03 | 1.08 | 0.97 |
| Fixing rate [%] | 84 | 86 | 90 | 81 |
| Evaluation | Good | Good | Very | Good |
| | | | good | |
| Releasability | | | | |
| Toner mount amount [mg/cm²] | 1.5 | 1.5 | 1.6 | 1.2 |
| Evaluation | Good | Good | Very | Good |
| | | | good | |

TABLE 4

| | | Comparative Example | | | | |
|---|---|---|---|---|---|---|
| | | 1 | 2 | 3 | 4 | 5 |
| Releasing agent | | | | | | |
| Type | | D | E | F | G | H |
| Maximum | Carboxylic acid | 82 | 93 | 82 | 95 | 95 |
| peak | component | | | | | |
| carbon | (Wc) [% by mass] | | | | | |
| number | Alcohol | 74 | 74 | 90 | 74 | 98 |
| content | component | | | | | |
| | (Wa) [% by mass] | | | | | |

| | | | | | |
|---|---|---|---|---|---|
| Hydrophobic silica | 1 | 1 | 1 | 1 | 1 |
| content amount [part by mass] | | | | | |
| Thermal characteristic analysis | | | | | |
| Endothermic start temperature [° C.] | 50.3 | 53.8 | 54 | 48.2 | 44.6 |
| Endothermic peak temperature [° C.] | 70.1 | 71.8 | 72.0 | 58.1 | 54.0 |
| Maximum thermal expansion | 3.55 | 1.29 | 1.01 | 1.89 | 0.08 |
| coefficient (Vₘₐₓ) [%] | | | | | |
| Specific surface measurement | | | | | |
| S₁[m²/g] | 1.81 | 1.80 | 1.84 | 1.82 | 1.79 |
| S₂[m²/g] | 1.38 | 1.43 | 1.45 | 1.38 | 1.61 |
| Specific surface area decreasing | 23.7 | 20.4 | 21.0 | 24.4 | 9.9 |
| rate [%] | | | | | |
| Evaluation 1 | | | | | |
| Heat-resisting preservation | | | | | |
| stability | | | | | |
| Mesh passage rate [%] | 80.8 | 85.7 | 85 | 71.9 | 64.5 |
| Evaluation | Good | Good | Good | Poor | Poor |
| Evaluation 2 | | | | | |
| Image density | | | | | |
| Under 23° C. 50% RH environment | 1.27 | 1.23 | 1.24 | 1.22 | 1.23 |
| Under 45° C. 16% RH environment | 0.91 | 0.87 | 0.93 | 0.79 | 1.00 |
| Evaluation | Poor | Poor | Poor | Poor | Good |
| Fixability | | | | | |
| Density after friction | 1.06 | 1.01 | 1.02 | 1.10 | 1.07 |
| Fixing rate [%] | 88 | 84 | 85 | 92 | 89 |
| Evaluation | Good | Good | Good | Very | Good |
| | | | | good | |
| Releasability | | | | | |
| Toner mount amount [mg/cm²] | 1.7 | 1.7 | 1.6 | 1.7 | 1.6 |
| Evaluation | Very | Very | Very | Very | Very |
| | good | good | good | good | good |

TABLE 5

| | | Comparative Example | | | |
|---|---|---|---|---|---|
| | | 6 | 7 | 8 | 9 |
| Releasing agent | | | | | |
| Type | | I | J | G | G |
| Maximum | Carboxylic acid | 95 | 88 | 95 | 95 |
| Peak | component | | | | |
| carbon | (Wc) [% by mass] | | | | |
| number | Alcohol | 82 | 90 | 74 | 74 |
| content | component | | | | |
| | (Wa) [% by mass] | | | | |

| | | | | |
|---|---|---|---|---|
| Hydrophobic silica | 1 | 1 | 2 | 2.5 |
| content amount [part by mass] | | | | |
| Thermal characteristic analysis | | | | |
| Endothermic start temperature [° C.] | 38.8 | 47.9 | 48.2 | 48.2 |
| Endothermic peak temperature [° C.] | 51.1 | 59.8 | 58.1 | 58.1 |
| Maximum thermal expansion | 2.66 | 0.68 | 1.89 | 1.89 |
| coefficient (Vₘₐₓ) [%] | | | | |
| Specific surface measurement | | | | |
| S₁ [m²/g] | 1.81 | 1.82 | 2.23 | 2.46 |
| S₂ [m²/g] | 1.35 | 1.39 | 1.69 | 1.96 |
| Specific surface area decreasing | 25.3 | 23.5 | 24.0 | 20.1 |
| rate [%] | | | | |
| Evaluation 1 | | | | |
| Heat-resisting preservation | | | | |
| stability | | | | |
| Mesh passage rate [%] | 44.0 | 77.1 | 79.2 | 91.1 |
| Evaluation | Poor | Poor | Poor | Good |
| Evaluation 2 | | | | |
| Image density | | | | |
| Under 23° C. 50% RH environment | 1.20 | 1.21 | 1.24 | 1.30 |
| Under 45° C. 16% RH environment | 0.76 | 0.80 | 0.97 | 1.19 |
| Evaluation | Poor | Poor | Poor | Good |
| Fixability | | | | |
| Density after friction | 1.08 | 1.09 | 1.01 | 0.94 |
| Fixing rate [%] | 90 | 91 | 84 | 78 |
| Evaluation | Very | Very | Good | Poor |
| | good | good | | |
| Releasability | | | | |
| Toner mount amount [mg/cm²] | 1.7 | 1.6 | 1.3 | 1.1 |
| Evaluation | Very | Very | Good | Poor |
| | good | good | | |

According to Examples 1 to 4, the toner includes toner base particles and an external additive. The toner base particles include a binder resin and a releasing agent. The external additive adheres to the surface of the toner base particles. The releasing agent is an ester wax, and the ester wax includes a carboxylic acid component and an alcohol component. It is shown that: an electrostatic charge image developing toner, in which a content in a fraction of the carbon number that indicates the maximum peak in the carbon number distribution is 90% by mass or more of the carboxylic acid component or of the alcohol component and the endothermic start temperature of the releasing agent is 50° C. or more, is excellent in releasability between the fixing roller and the recording medium on which the image is formed, heat-resisting preservation stability, and fixability, and allows forming of an image having a desired image density even in the case of continuously performing image formation under high temperature environment.

In addition, according to Examples 1 to 3, it is shown that the electrostatic charge image developing toner is further excellent in fixability and the releasability between the fixing roller and the recording medium on which the image is formed. A silica content in the electrostatic charge image developing toner is 1.5 parts by mass or less with respect to 100 parts by mass of the toner base particles. In addition, according to a comparison between the toner including the same amount of the external additive in each of Examples 1 and 2 with the toner in Example 3, it is shown that: with electrostatic charge image developing toner having a specific surface area decreasing rate of 11% or more and 14% or less, it is easier to suppress a decrease in image density in the case of continuously performing image formation under high temperature environment.

According to Comparative Examples 1 to 4 and 6 to 8, it is shown that: for one of the carboxylic acid component and the alcohol component that are included in the ester wax, if the content in a fraction of the carbon number that indicates the maximum peak in the carbon number distribution is too small, and in the case of continuously performing image formation under high temperature environment, it is difficult to form an image having a desired image density. This is considered to be because: due to the image formation operation performed under high temperature environment, as shown in FIGS. 4 and 5, the releasing agent, which is thermally-expanded and exposed on the surface of the toner base particle, covers the external additive attached to the surface of the toner base particles.

According to Comparative Examples 4 to 8, it is shown that: when the endothermic start temperature of the releasing agent is too low, the heat-resisting preservation stability of the toner is deteriorated. This is considered to be because: in the case of storing toner under high temperature environment, a releasing agent component is likely to exude from the toner particles to the surface of the toner particles.

According to Comparative Example 9, the toner in which, with one of the carboxylic acid component and the alcohol component that are included in the ester wax, the content in the fraction of the carbon number that indicates the maximum peak in the carbon number distribution is too small and which has 2.5 parts by mass of silica with respect to 100 parts by mass of the toner base particles is excellent in heat-resisting preservation stability, and in the case of continuously performing image formation under high temperature environment, it is possible to form an image having a desired image density, but the releasability between the fixing roller and the recording medium on which the image is formed, and the fixability are deteriorated. This is considered to be because: although including silica in the external additive allows increasing toner fluidity, a presence of the releasing agent on the surface of the toner particles blocks fixing.

What is claimed is:

1. An electrostatic charge image developing toner, comprising
toner base particles including a binder resin and a releasing agent; and
an external additive attached to a surface of the toner base particles, wherein
the releasing agent is an ester wax,
the ester wax includes a carboxylic acid component and an alcohol component,
of the carboxylic acid component, a content in a fraction of a carbon number indicating a maximum peak in a carbon number distribution measured by gas chromatography is 90% by mass or more,
of the alcohol component, a content in a fraction of a carbon number indicating a maximum peak in a carbon number distribution measured by gas chromatography is 90% by mass or more, and
an endothermic start temperature of the releasing agent is 50° C. or more, the endothermic start temperature being measured using a differential scanning calorimeter (DSC).

2. An electrostatic charge image developing toner according to claim 1, wherein
a maximum endothermic peak temperature in a DSC curve of the releasing agent is 60° C. or more, the DSC curve being measured using the differential scanning calorimeter (DSC).

3. An electrostatic charge image developing toner according to claim 1, wherein
a maximum value (Vₘₐₓ) of a thermal expansion coefficient of the releasing agent is 0.1% or less, the thermal expansion coefficient being measured using thermomechanical analysis (TMA).

4. An electrostatic charge image developing toner according to claim 1, wherein
the external additive includes silica, and
a content of the silica is 1.5 parts by mass or less with respect to 100 parts by mass of the toner base particles.

5. An electrostatic charge image developing toner according to claim 1, wherein
when assuming, as S₁, a BET specific surface area of unused toner after being allowed to stand for 24 hours under an environment at 23° C. and 50% RH, and assuming, as S₂, a BET specific surface area of unused toner after being allowed to stand for 24 hours under an environment at 45° C. and 16% RH, a specific surface area decreasing rate is 11% or more and 14% or less, the specific surface area decreasing rate being calculated by a formula below:
Specific surface area decreasing rate [%]=((S₁−S₂)/S₁)×100.

6. An electrostatic charge image developing toner according to claim 1, wherein
the carboxylic acid component included in the ester wax is a component derived from behenic acid or a component derived from palmitic acid.

7. An electrostatic charge image developing toner according to claim 1, wherein
the alcohol component included in the ester wax is a component derived from behenyl alcohol or a component derived from stearyl alcohol.
